(19) United States
(12) Patent Application Publication
(10) Pub. No.: US 2007/0124556 A1
(43) Pub. Date: May 31, 2007

(54) Method and apparatus for restricting playback of recorded digital signals

(76) Inventors: Piero Andreas Madar, Indianapolis, IN (US); Richard Earl Jones, Plainfield, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/580,997

(22) PCT Filed: Dec. 8, 2004
(86) PCT No.: PCT/US04/41715

§ 371 Date: May 26, 2006

Related U.S. Application Data
(60) Provisional application No. 60/527,946, filed on Dec. 8, 2003.

(51) Int. Cl. G06F 12/00; G06F 13/28; G06F 13/00

(52) U.S. Cl. 711/164

(57) ABSTRACT

A password protection function enables a user to assign a password to signals including audio and/or video signals recorded by their own digital recording apparatus, and is capable of providing both backward and forward compatibility for older and future digital playback apparatuses, respectively. According to an exemplary embodiment, a method for performing digital recording and playback includes steps of enabling a user to record digital signals onto a digital storage medium, receiving a password from the user, storing the password in at least one unreserved data field on the digital storage medium, wherein the at least one unreserved data field is included in a first presentation sequence for the recorded digital signals, and requiring the password to be input before playing back the recorded digital signals.

### CROSS REFERENCE TO RELATED APPLICATION

This application claims priority to and all benefits accruing from a provisional application filed in the United States Patent and Trademark Office on Dec. 8, 2003, and there assigned Ser. No. 60/527,946.

### BACKGROUND OF THE INVENTION

1. Field of the Invention

The present invention generally relates to the field of digital recording and playback, and more particularly, to a password protection function that enables a user to assign a password to signals including audio and/or video signals recorded by their own digital recording apparatus, and requires user input of the password before the recorded signals can be played back. The present invention is also capable of providing both backward and forward compatibility with older and future digital playback apparatuses, respectively.

2. Background Information

Digital recording and playback apparatuses such as recordable digital versatile disc (DVD) players are capable of recording and playing back digital signals including audio and/or video signals. There are presently a number of different format standards available for DVDs to be recorded, erased and re-recorded. The acronym DVD+RW/DVD+VR refers to an exemplary format standard that allows digital content on a DVD to be recorded, erased, and re-recorded by a user.

At present, format standards that allow digital content on a DVD to be recorded, erased and re-recorded by a user (e.g., DVD+RW/DVD+VR) do not provide a means for restricting user access to recordings. Other format standards that prohibit user recording altogether (e.g., DVD-ROM/DVD-video), on the other hand, may accommodate a parental management feature that allows DVD distributors to release multiple rating versions of a movie on a single DVD and allows parents to lock a desired rating into their DVD player with a password, so that potentially objectionable content will not be played. However, this parental management feature does not enable users to provide password protection for recordings made using their own recordable DVD player.

One technique for allowing users to provide password protection for recordings made using their own DVD recorders is disclosed in United States Patent Application Publication No. US 2003/0126596. In particular, this publication discloses a technique for providing password protection that uses various reserved data fields on a DVD for storing and retrieving password data. This type of password protection technique, however, is deficient in that it is proprietary to a specific manufacturer's recordable DVD player. That is, this type of password protection technique requires the use of a proprietary algorithm that is capable of storing and retrieving password data to and from certain reserved data fields on a DVD. Without the applicable proprietary algorithm, the password protection technique can not be effectively implemented. Accordingly, the aforementioned type of password protection technique may not be backward compatible (i.e., won't work on older players), or forward compatible (i.e., won't work on future players and/or other manufacturers' players).

Accordingly, there is a need for a password protection function that addresses the foregoing problems and thereby enables users to provide password protection for recordings made using their own digital recording apparatus (e.g., recordable DVD player), and is also capable of providing both backward and forward compatibility. The present invention addresses these and/or other issues.

### SUMMARY OF THE INVENTION

In accordance with an aspect of the present invention, a method for performing digital recording and playback is disclosed. According to an exemplary embodiment, the method comprises steps of enabling a user to record digital signals onto a digital storage medium, receiving a password from the user, storing the password in at least one unreserved data field on the digital storage medium, wherein the at least one unreserved data field is included in a first presentation sequence for the recorded digital signals, and requiring the password to be input before playing back the recorded digital signals.

In accordance with another aspect of the present invention, a digital recording and playback apparatus is disclosed. According to an exemplary embodiment, the digital recording and playback apparatus comprises interface means for interfacing the digital recording and playback apparatus with a digital storage medium. Control means enable a user to record digital signals onto the digital storage medium, receive a password from the user, and cause the password to be stored in at least one unreserved data field on the digital storage medium. The at least one unreserved data field is included in a first presentation sequence for the recorded digital signals.

In accordance with yet another aspect of the present invention, a digital storage medium is disclosed. According to an exemplary embodiment, the digital storage medium comprises a plurality of reserved data fields, a plurality of unreserved data fields, and a first presentation sequence for digital signals recorded by a user. At least one of the plurality of unreserved data fields is stored a user-assigned password for the recorded digital signals, and the first presentation sequence includes the at least one of the plurality of unreserved data fields. Input of the user-assigned password is required before playing back the recorded digital signals.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram illustrating a digital recording and playback apparatus suitable for implementing the present invention;

FIG. 2 is a flowchart illustrating steps of a presentation sequence for providing password protection according to an exemplary embodiment of the present invention; and

FIG. 3 is a flowchart illustrating steps for assigning a password to a recording according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

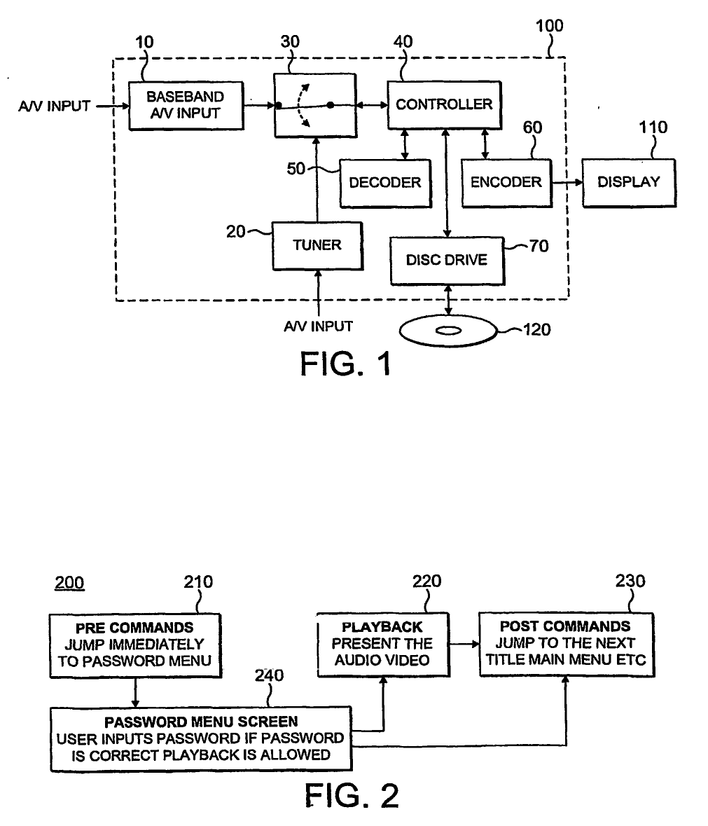

Referring now to the drawings, and more particularly to FIG. 1, a block diagram illustrating a digital recording and playback apparatus 100 suitable for implementing the present invention is shown. For purposes of example and explanation, digital recording and playback apparatus 100 is embodied as a recordable DVD player capable of recording and playing back digital audio and/or video signals, although other types of digital recording and playback apparatuses may also be used according to the present invention. As will be described later herein, digital recording and playback apparatus 100 includes a password protection function that enables users to assign a password to signals including audio and/or video signals recorded by digital recording and playback apparatus 100, and is capable of providing both backward and forward compatibility for older and future digital playback apparatuses, respectively.

As shown in FIG. 1, digital recording and playback apparatus 100 comprises input means such as baseband audio and/or video (A/V) input block 10, tuning means such as tuner 20, switching means such as switch 30, control means such as controller 40, encoding means such as encoder 50, decoding means such as decoder 60, and interface means such as disc drive 70. Some of the foregoing elements of digital recording and playback apparatus 100 may be embodied using integrated circuits (ICs), and some elements may for example be included on one or more ICs. For clarity of description, certain conventional elements associated with digital recording and playback apparatus 100 such as certain control signals, power signals and/or other elements may not be shown in FIG. 1. Also shown in FIG. 1 are output means such as display 110 and data storage means such as digital storage medium 120.

Baseband A/V input block 10 is operative to receive signals including baseband audio and/or video signals from one or more signal sources. Tuner 20 is operative to receive signals including audio and/or video signals from one or more signal sources such as terrestrial, cable, satellite, internet and/or other broadcast sources, and to perform a tuning process on the received signals to generate baseband signals. Tuner 20 may be an optional element of digital recording apparatus 100. Switch 30 is operative to perform a switching function by selectively providing output signals from either baseband ANV input block 10 or tuner 20 to controller 40.

Controller 40 is operative to perform various signal processing and control functions of digital recording and playback apparatus 100. According to an exemplary embodiment, controller 40 is operative to control and/or enable functions including recording, playback, and password protection functions of digital recording and playback apparatus 100. Accordingly, controller 40 is operative to control various elements of digital recording and playback apparatus 100 including switch 30, encoder 50, decoder 60, and disc drive 70. Further details regarding controller 40 will be provided later herein.

Encoder 50 is operative to perform functions including an encoding function. According to an exemplary embodiment, encoder 50 is operative to encode signals provided from controller 40, and is capable of performing Moving Picture Expert Group (MPEG) encoding and/or other types of encoding. Decoder 60 is operative to perform functions including a decoding function. According to an exemplary embodiment, decoder 60 is operative to decode signals provided from controller 40, and is capable of performing MPEG decoding and/or other types of decoding. Decoder 60 may also include analog format encoding means such as a National Television Standards Committee (NTSC) encoder, Phase Alternating Line (PAL) encoder, and/or other type of analog format encoder. Disc drive 70 is operative to perform functions including an interface function between digital recording and playback apparatus 100 and digital storage medium 120. According to an exemplary embodiment, disc drive 70 is capable of writing and reading digital data to and from digital storage medium 120 under the control of controller 40.

Display 110 is operative to provide visual displays and/or other outputs responsive to signals output from decoder 60 under the control of controller 40. Digital storage medium 120 is operative to store digital data including audio and/or video data. According to an exemplary embodiment, digital storage medium 120 is embodied as a recordable DVD, but may also be embodied as another type of digital storage device such as a video compact disc (VCD), hard disc (HD), static random access memory (SRAM), or other device. Further details regarding digital storage medium 120 will be provided later herein.

Referring to FIG. 2, a flowchart 200 illustrating steps of a presentation sequence for providing password protection according to an exemplary embodiment of the present invention is shown. In particular, FIG. 2 shows a presentation sequence for providing password protection using a recordable DVD player according to the principles of the present invention. As described in the DVD player specification (e.g., DVD specifications for Read-Only Disc, Part 3 Video, Version 1.13), a given DVD recording (i.e., title) is represented as a “program chain” (PGC) made up of a plurality of linked data fields or cells. A given DVD+RW/DVD+VR recording, for example, is normally contained within a single PGC. The term “presentation sequence” may be used herein to refer to a PGC or other type of similar sequence. The data that defines how a given PGC is presented may be referred to as “PGC information” (PGCI). As will be described later herein, the present invention restricts access to a given DVD recording by storing a user-assigned password for a given recording in the same PGC as the recording itself. Accordingly, all DVD players on the market (i.e., past, present, and future) that are compliant with the DVD player specification are necessarily capable of implementing the password protection function of the present invention.

As indicated in FIG. 2, the presentation of a PGC in a DVD player occurs in three basic stages: execution of PRE commands, playback of audio and/or video content, and execution of POST commands represented by steps 210, 220, and 230, respectively. “Commands” are a set of internal DVD instructions that the DVD player must perform. For example, the PRE commands of step 210 may include instructions such as selecting correct audio language or sub-picture tracks, and jumping to a menu or title on the DVD. The POST commands of step 230 may for example include instructions for jumping to another menu (e.g., main menu) or title on the DVD.

According to the principles of the present invention, the set of available commands within a DVD player can be authored on a recorded DVD in such a manner as to allow or prohibit the playback of any given PGC (i.e., recording), based only on user input. As indicated in FIG. 2, the password protection function of the present invention inserts additional PRE commands into the normal presentation sequence discussed above. These PRE commands cause playback to be diverted to a password menu screen represented by step 240 in FIG. 2. The password menu screen prompts the user to input a password such as a sequence of alphabetic and/or numerical characters. If the user inputs a password that matches a stored password that was authored on the DVD, then playback proceeds normally at step 220. Alternatively, if the user fails to input the stored password correctly, then POST commands are performed at step 230. For example, if the user fails to input the stored password correctly, then the user may be presented with a main menu to select another recording (e.g., title) for playback. According to an exemplary embodiment, the steps of FIG. 2 are performed under the control of controller 40 of digital recording and playback apparatus 100.

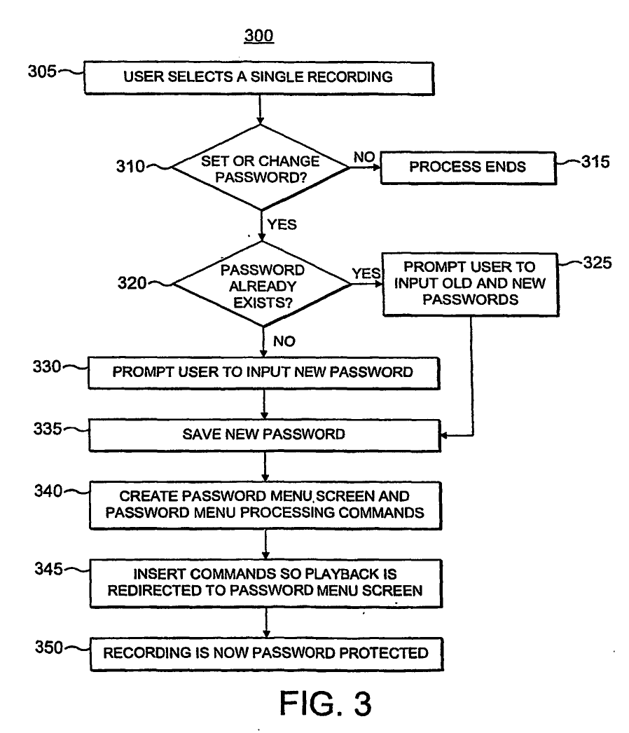

Referring to FIG. 3, a flowchart 300 illustrating steps for assigning a password to a recording according to an exemplary embodiment of the present invention is shown. For purposes of example and explanation, the steps of FIG. 3 will be described with reference to digital recording and playback apparatus 100 of FIG. 1. The steps of FIG. 3 are exemplary only, and are not intended to limit the present invention in any manner.

At step 305, a user selects a single recording to be password protected. According to an exemplary embodiment, the selected recording has been previously created by a user via digital recording and playback apparatus 100 or another digital recording apparatus. That is, the selected recording is not from a storage medium such as a DVD-ROM. The user may select the recording at step 305 via a user input device such as a hand-held remote control device or other device (not shown in FIGS.) responsive to an on-screen menu provided on display 110 under the control of controller 40 that lists the recordings currently stored on digital storage medium 120. The recordings may for example represent audio and/or video presentations (e.g., movies, television shows, etc.), and/or other content that were recorded by a user on digital storage medium 120 using digital recording and playback apparatus 100 and/or another digital recording apparatus.

At step 310, the user is provided an opportunity to either set or change a password for the selected recording. According to an exemplary embodiment, this option may be provided to the user at step 310 via an on-screen menu provided on display 110 under the control of controller 40. If the user decides not to set or change a password at step 310, process flow advances to step 315 where the process ends.

Alternatively, if the user decides to set or change a password at step 310, process flow advances to step 320 where a determination is made as to whether a password already exists for the selected recording. According to an exemplary embodiment, controller 40 makes the determination at step 320 by causing disc drive 70 to read and provide data from the PGC for the selected recording on digital storage medium 120. As will be described later herein, a user-assigned password for a given recording is stored in the same PGC as the recording itself.

If the determination at step 320 is positive, process flow advances to step 325 where the user is prompted to input both the old and new passwords for the selected recording. According to an exemplary embodiment, the user is prompted to input the old and new passwords at step 325 via an on-screen menu provided on display 110 under the control of controller 40. The user may input the old and new passwords at step 325 by providing inputs to digital recording and playback apparatus 100 via a user input device such as a hand-held remote control device or other user input device (not shown in FIGS.). Although not expressly indicated in FIG. 3, the user may be given a limited number of attempts to correctly input the old password at step 325. If the user fails to correctly input the old password within these limited number of attempts, the process may end. For purposes of example and explanation, however, it is assumed in FIG. 3 that the user correctly inputs the old password at step 325. From step 325, process flow advances to step 335 where the new password is saved on digital storage medium 120, as will be described later herein.

Alternatively, if the determination at step 320 is negative, process flow advances to step 330 where the user is prompted to input only the new password. According to an exemplary embodiment, the user is prompted to input the new password at step 330 via an on-screen menu provided on display 110 under the control of controller 40. The user may input the new password at step 330 by providing inputs to digital recording and playback apparatus 100 via a user input device such as a hand-held remote control device or other user input device (not shown in FIGS.).

From step 330, process flow advances to step 335 where the new password is saved. According to an exemplary embodiment, the new password is stored in one or more unreserved data fields on digital storage medium 120 included in the same PGC as the selected recording. A unreserved data field is a data field that is not designated for a specific function in a specification for a particular storage medium, such as a DVD. In particular, the password may be stored at step 335 in the navigation PRE commands of the given PGC. . It is noted that digital storage medium 120 includes a plurality of reserved data fields, and a plurality of unreserved data fields. As referred to herein, a “reserved data field” is a data field that is reserved for future versions of a given standard or specification (e.g., DVD specifications, etc.). Reserved data fields may for example include prescribed data (e.g., all bits set to zero, etc.). Alternatively, an “unreserved data field” is a data field other than a reserved data field. By storing the user-assigned password in one or more unreserved data fields on digital storage medium 120 included in the same PGC as the selected recording, the present invention advantageously ensures that the password protection function is both backward and forward compatible with older and future digital playback apparatuses, respectively.

At step 340, a password menu screen and password menu processing commands are created. According to an exemplary embodiment, controller 40 creates the password menu screen at step 340 by creating video object sets (VOBs) that represent the password menu screen and causing those VOBs to be stored on digital storage medium 120 via disc drive 70 as a separate PGC. That is, the password menu screen created at step 340 may be stored as a different PGC than the PGC for the selected recording. Alternatively, the password menu screen created at step 340 could be stored in the same PGC as the selected recording. Also according to an exemplary embodiment, controller 40 creates password menu processing commands at step 340 that are stored on digital storage medium 120 via disc drive 70. The password menu processing commands enable a digital playback apparatus such as a DVD player to compare a user input password with the stored password for the selected recording, and allow or disallow the selected recording to be played back depending on whether the user input password matches the stored password, as previously discussed in FIG. 2.

At step 345, commands are inserted so that playback is redirected to the password menu screen created at step 340. According to an exemplary embodiment, controller 40 inserts PRE commands into the PRE command table of the PGC for the selected recording. For example, controller 40 may insert a first PRE command to set a register for setting sub-picture settings, and also insert a second PRE command (e.g., CalISS command in the DVD specification) that causes digital recording and playback apparatus 100 to jump to the PGC for the password menu screen. These new PRE commands ensure that the password menu screen created at step 340 will automatically be displayed whenever a user attempts to playback the selected recording.

At step 350, the selected recording is now password protected. As a result of this password protection, the user-assigned password for the selected recording must be input before it can be played back. The steps of FIG. 3 may be repeated for each recording on digital storage medium 70 that the user desires to provide password protection.

As described herein, the present invention provides a password protection function that enables users to provide password protection for recordings made using their own digital recording apparatus (e.g., recordable DVD player) and is both backward and forward compatible with older and future digital playback apparatuses, respectively.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for performing digital recording and playback, comprising steps of:
enabling a user to record digital signals onto a digital storage medium;
receiving a password from said user;
storing said password in at least one unreserved data field on said digital storage medium, wherein said at least one unreserved data field is included in a first presentation sequence for said recorded digital signals; and
requiring said password to be input before playing back said recorded digital signals.

2. The method of claim 1, wherein said digital storage medium is a DVD.

3. The method of claim 1, further comprising the step of storing menu data representing a password menu screen on said digital storage medium.

4. The method of claim 3, wherein said menu data is stored in a second presentation sequence different from said first presentation sequence.

5. The method of claim 4, wherein said first and second presentation sequences represent different program chains.

6. The method of claim 3, further comprising the step of storing at least one command on said digital storage medium that enables display of said password menu screen.

7. The method of claim 6, wherein said password menu screen is displayed responsive to a user's attempt to playback said recorded digital signals.

8. A digital recording and playback apparatus, comprising:
interface means for interfacing said digital recording and playback apparatus with a digital storage medium; and
control means for enabling a user to record digital signals onto said digital storage medium, receiving a password from said user, and causing said password to be stored in at least one unreserved data field on said digital storage medium, wherein said at least one unreserved data field is included in a first presentation sequence for said recorded digital signals.

9. The digital recording and playback apparatus of claim 8, wherein said digital storage medium is a DVD.

10. The digital recording and playback apparatus of claim 8, wherein said control means further causes menu data representing a password menu screen to be stored on said digital storage medium.

11. The digital recording and playback apparatus of claim 10, wherein said menu data is stored in a second presentation sequence different from said first presentation sequence.

12. The digital recording and playback apparatus of claim 1, wherein said first and second presentation sequences represent different program chains.

13. The digital recording and playback apparatus of claim 10, wherein said control means further causes at least one command that enables display of said password menu screen to be stored on said digital storage medium.

14. The digital recording and playback apparatus of claim 13, wherein said control means enables display of said password menu screen responsive to a user's attempt to playback said recorded digital signals.

15. The digital recording and playback apparatus of claim 14, wherein said control means further requires said password to be input responsive to said password menu screen before playing back said recorded digital signals.

16. A digital storage medium comprising:
a plurality of reserved data fields; and
a plurality of unreserved data fields and a first presentation sequence for digital signals recorded by a user; and
wherein at least one of said unreserved data fields is stored a user-assigned password for said recorded digital signals, said first presentation sequence includes said at least one of said unreserved data field, and input of said user-assigned password is required before playing back said recorded digital signals.

17. The digital storage medium of claim 16, wherein said digital storage medium is a DVD.

18. The digital storage medium of claim 16, further comprising a second presentation sequence for a password menu screen.

19. The digital storage medium of claim 18, wherein said first and second presentation sequences represent different program chains.

20. The digital storage medium of claim 18, wherein said password menu screen prompts input of said password and is displayed responsive to an attempt to playback said recorded digital signals.
